(19) United States
(12) Patent Application Publication
(10) Pub. No.: US 2019/0114275 A1
(43) Pub. Date: Apr. 18, 2019

(54) NODE CONTROLLER TO MANAGE ACCESS TO REMOTE MEMORY

(71) Applicant: HEWLETT PACKARD ENTERPRISE DEVELOPMENT LP, Houston, TX (US)

(72) Inventor: Frank R. Dropps, Eagan, MN (US)

(21) Appl. No.: 15/786,098

(22) Filed: Oct. 17, 2017

(51) Int. Cl. G06F 13/376; G06F 12/0817

(52) U.S. Cl. CPC G06F 13/376; G06F 12/0835; G06F 12/0817

(57) ABSTRACT

A node controller to manage access to and provide responses from a remote memory for a plurality of processor nodes. A learning block monitors requests to a given data block in the remote memory and monitors parameters associated with the requests. The learning block updates a respective weighting value for each of the parameters associated with the requests to the given data block. Event detection circuitry stores the parameters and the weighting values for each of the parameters associated with an address for the given data block to determine a subsequent memory action for the prospective data block in the remote memory.

### BACKGROUND

A memory controller is a digital circuit that manages the flow of data going to and from the processor's main memory. The memory controller can be a separate chip or integrated into another chip, such as being placed on the same die or as an integral part of a microprocessor. The main memory is local to the processor and is thus, not directly accessible by other processors. In contrast to the local memory controller to access local processor memory, a node controller is a circuit or system that manages the flow of data for one or more processors to a remote memory. Thus, the node controller controls access to the remote memory by each of the one or more processors.

### BRIEF DESCRIPTION OF THE DRAWINGS

FIG. 1 illustrates an example node circuit to determine future memory actions and manage memory accesses for remote memory.

FIG. 2 illustrates an example of event detection circuitry to determine future memory actions for remote memory.

FIG. 3 illustrates an example system to determine future memory actions and manage memory accesses for remote memory.

FIG. 4 illustrates an example method to determine future memory actions and manage memory accesses for remote memory.

### DETAILED DESCRIPTION

Circuits, systems, and methods are disclosed to control access to remote memory based on machine learning. This includes learning memory access patterns (heuristically) based on past memory accesses to the remote memory. For example, learning is based on artificial intelligence, such as via classifiers that observe memory access patterns. Weighting values can be assigned to the learned patterns based on the frequency of the memory accesses and parameters relating to conditions when the memory accesses have occurred. For example, the parameter conditions can include time of day, day of the week, day of the month, type of request, and address range of the request. Parameter values for a set of the conditions can be monitored to control subsequent memory actions, which may include retrieving (e.g., pre-fetching) data from a determined memory address location of the remote memory before it is requested by a given processor node based on evaluating the assigned weighting values and the parameter values.

In one example, Content Addressable Memory (CAM) memories can be employed to store the parameter values and utilized for high-speed lookup to determine likely future memory actions. For instance, the memory actions can include memory requests (e.g., reads, memory writes). The memory actions may also include other supervisory or management actions that change a state for a block of memory (e.g., modified, exclusive, shared or invalid) to facilitate coherency of the data that is stored in the remote memory. By way of example, in response to parameter values of a current memory request matching stored parameters of a CAM row line, the another memory associated with the CAM automatically provides weighted values, which may be summed from multiple CAM row line matches. The value from the last CAM search can also be accumulated unless the CAM rows are assigned to clear history. In that example, the past request history can be cleared. In some examples, the total weighting in which primary CAM row lines match can be input into a secondary CAM. The secondary CAM produces a state change to trigger the speculative memory action to be implemented based on current parameter values. The weighting values accessed fin accordance with the primary CAM search can be summed to generate a summed weighting value that can be compared to a threshold. If the threshold is exceeded, the secondary CAM can be evaluated to determine likely future memory actions as well as to update the weighting values and parameters.

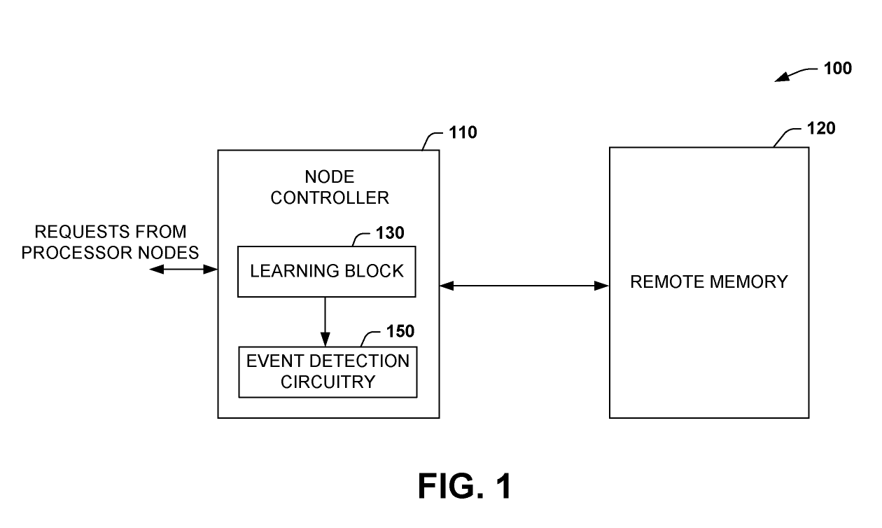

FIG. 1 illustrates an example circuit 100 to determine future memory actions for a remote memory. The circuit 100 includes a node controller 110 to manage access to and provide responses from a remote memory 120 for a plurality of processor nodes (not shown). As used herein, the term remote memory refers to volatile and/or non-volatile memory that provides a shared memory resource for one or more of the processor nodes. The node controller 110 includes a learning block 130 to monitor requests to a given data block in the remote memory 120 and to monitor parameters associated with the requests. As used herein, the term parameters refers to conditions of the processor nodes when the monitored requests are generated. Example parameters can include a time of day, day of the week, an address range for the request, a type of memory request, and so forth. Other example parameters are described herein below. The learning block 130 updates a respective weighting value for each of the parameters associated with the requests to the given data block. The respective weighting values thus change over time to indicate a current likelihood that a subsequent memory action will occur with respect to a prospective data block in the remote memory 120 that is accessed following each of the past requests.

By way of example, it may be learned that when memory request “A” occurs, that within a few clock cycles (or some other predetermined time window) that memory action “B” will follow. Thus, the parameter values when memory action “A” occurs can be updated to indicate a higher likelihood that memory action “B” will occur. During a current processor node request, when the address for memory action “A” matches along with the weighting values retrieved in response to current parameter values, memory action “B” can be executed before actually being requested by a given processor node. When the processor node actually requests memory action “B”, the node controller 120 can fulfill the request from local node resources (e.g., local buffer) as opposed to the slower process of having to access the remote memory 120 at the time of the request.

Event detection circuitry 140 stores the parameters and the weighting values for each of the parameters (as updated by the learning block 130) associated with an address for the given data block in the remote memory 120. The event detection circuitry 140 determines a subsequent memory action to execute for the prospective data block in the remote memory based on matching an address of a current request to the given data block and comparing current parameter values associated with the current request relative to the stored parameters.

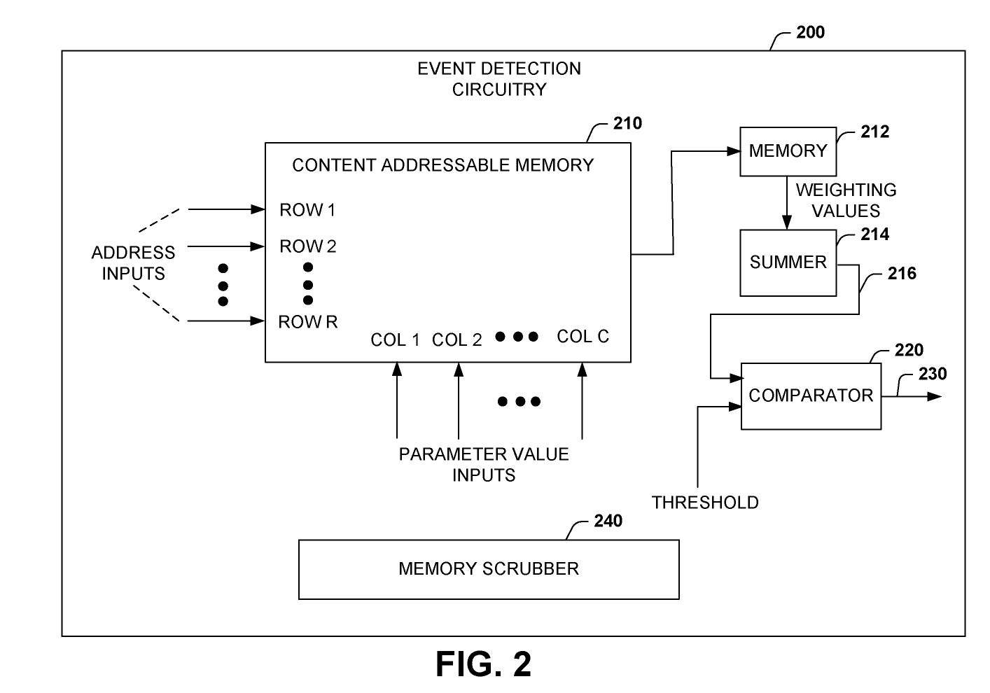

The event detection circuitry 140 can include a comparator (see e.g., FIG. 2) to compare weighting values that are retrieved in response to current parameter conditions associated with a current request for the given data. The weighting values for parameters that match are summed (or other processor operation), and the summed weighting values are compared to a threshold. The summed weighting values thus are retrieved based on the current parameter values, and the event detection circuitry 140 determines the subsequent memory action if the summed weighting values exceed the threshold. The circuit 100 thus employs heuristics to predict future needs of processor nodes by predicting that data, which has not yet been requested from the remote memory 120, will be needed in the near future. When a potential match of a future memory action occurs based on the weighting values, the circuit 100 can provide an output to trigger the future memory action.

As mentioned, the future memory action can include activating the node controller 110 to execute a request to retrieve (e.g., pre-fetch) a predicted data block, such as a read request or write request for the data, from the remote memory 120 before one of the processor nodes issues the request. This saves time for the processor nodes in having to access the remote memory 120 themselves and increases the efficiency of access to the remote memory since processor node hand shaking to the node controller 110 when accessing the remote memory can be reduced. That is, since the node controller 110 can retrieve the predicted data block from the remote memory 120 and store it in a local buffer of the node controller, the request received from the processor node (assuming a match) can be provided to such processor node in a response without having to execute its retrieval in response to such request.

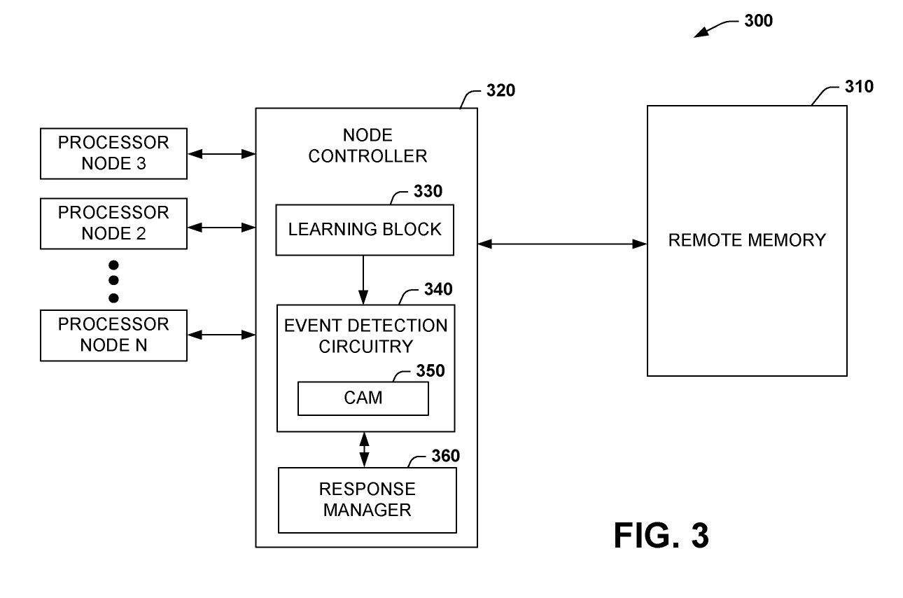

In one example, the event detection circuitry 140 can include a content addressable memory (CAM) (see e.g., FIGS. 2 and 3) having separate columns to store each of the parameters and a separate row assigned to each data block that has been previously requested by the processor nodes, where weighting values for the respective columns can be stored in a separate memory. In an example CAM implementation, the CAM receives the row and the parameters as inputs to perform a lookup of the weighting values in another memory. In another example, the CAM can be implemented as a ternary CAM (TCAM) to allow for the specification of “do not care state” inputs representing the parameters to the content addressable memory. The use of the “do not care” inputs can speed up a respective search request in the TCAM by excluding inputs that may not be relevant to a given search request. The “do not care” specifications can also broaden a respective search request since only a subset of the parameters has to be matched in order to detect whether or not a given memory condition has been detected.

In an example, the learning block 130 can be implemented as a classifier that monitors the past requests to a given data block in the remote memory 120 and updates the respective weighting value for each of the parameters as a statistical probability to indicate the likelihood of the subsequent memory action. The classifier can include rule-based machine learning circuits that combine a discovery component (e.g. typically a genetic algorithm) with a learning component (performing either supervised learning, reinforcement learning, or unsupervised learning). The classifier can identify a set of context-dependent rules (e.g., heuristics defined by the parameters described herein) that collectively store and apply knowledge in a piecewise manner in order to make predictions (e.g. behavior modeling, classification, data mining, regression, function approximation, and so forth). The predictions can be stored as the weighting values described herein which represent probabilities that a future memory action may occur based on the address and parameter inputs described herein. One example of a classifier is a support vector machine (SVM) to perform Bayesian learning based on memory requests and parameters but other learning block examples are also possible including neural networks. In one example, the node controller 120 can be implemented as a state machine to perform various processes that can be implemented as a number of states that respond to various inputs to transition between states. Example processes can include learning, event detection, parameter evaluation, processing requests from processor nodes, accessing the remote memory 120, and so forth.

FIG. 2 illustrates an example of event detection circuitry 200 to determine future memory actions and manage memory accesses to a remote memory. In this example, the event detection circuitry 200 includes a content addressable memory (CAM) 210 having separate columns shown as columns 1 through C to store each of the parameters and its associated weighting value. The CAM 210 includes a separate row shown as rows 1 through R assigned to each data block that has been previously requested by the processor nodes, where C and R are positive integers. The CAM 210 receives the row and the parameters as inputs. A separate memory 212 performs a lookup of the weighting values and retrieves them. As shown, the parameters described herein are applied to column inputs 1-C, whereas the rows 1-R receive address inputs that indicate which data blocks have been accessed.

The CAM 210 is a type of computer memory that can be used in very-high-speed searching applications. It is also known as associative memory, associative storage, or associative array, although the last term is more often used for a programming data structure. The CAM 210 compares input search data (e.g., tag) defined by the address and parameter inputs against a table of stored data, where the weighting values are returned via memory 212. In this example, weighting values are stored, updated, and/or retrieved as the matching data. In one particular example, the CAM 210 can be implemented as a ternary CAM (TCAM) to allow for the specification of do not care state inputs representing the parameters to the content addressable memory. The TCAM allows a third matching state of “X” or “don't care” for one or more bits in the stored data word, thus adding flexibility to the search. For example, a ternary CAM may have a stored word of “10XX0” which will match any of the four search words “10000”, “10010”, “10100”, or “10110”. For each parameter that matches, the CAM provides a corresponding weighted value from memory 212, which values are summed via a summer 214 to provide a summed weighting value 216.

In one example implementation, the subsequent memory action to take based on past memory requests can be stored in a column of the CAM 210. In another example, a primary TCAM can perform an initial search for parameter matches and provide weighting values via memory 212 based on the matched parameters. For instance, a comparator 220 compares the summed weighting value output 216 of the memory 212 to a threshold which triggers a secondary TCAM (not shown) via an output 230 to lookup the subsequent memory action if the weighting value output exceeds the threshold. If it does not exceed the threshold, then the subsequent memory action is not executed. The comparator 220 compares summed weighting values 216 retrieved from the stored parameters of the memory 212 to a threshold. The memory 212 provides weighting values based on the current parameter values matching the stored parameter values for a given data block (e.g., indexed by the address for the given data block). The event detection circuitry 200 determines the subsequent memory action if the summed weighting values 216 exceed the threshold. In another example, rather than store the weighting values in a separate memory 212, the weighting values along with the parameter values can be store in the CAM 210.

Example memory access conditions that are represented by the parameters for a given memory request can include a time of day, a day of the week, a day of the month, a month of the year, a type of memory request, or an address range of the request. Thus, if a particular address of the remote memory is consistently accessed on the first Tuesday of each month at a particular time, a high weighting value can be assigned via the learning block over time which indicates a future memory action should occur when the current parameter inputs match previous parameter conditions. For example, a given memory read to a given address that occurs on the same time each day (or other condition/conditions) may indicate that a subsequent memory read will occur after the given memory read. If such conditions are detected, the learning block can increase the probability in the form of the weighting value that the subsequent memory read will occur based on the address of the given memory read and the current parameter value of the time.

Other example parameter values can include a previous address accessed, an access request history, a processor address region, coherency directory information (e.g., to define a particular processors domain that is protected from other processors), a previous request history, or a running application identifier. A memory scrubber 240 can be provided to update the weighting values stored in the memory 212 depending on whether or not the future memory request is fulfilled by the subsequent memory action. For example, if the subsequent memory request which has been fulfilled (e.g., via response manager shown in FIG. 3) before a given future processor node request to the remote memory, and the future request is found not to have occurred, the weighting value for the subsequent memory action can be modified by the learning block 130 to indicate a lower probability that the subsequent memory action should have been executed.

FIG. 3 illustrates an example system 300 to determine future memory actions and manage memory accesses to a remote memory. The system 300 includes a remote memory 310 and a plurality of processor nodes shown as nodes 1-N. A node controller 320 manages access to and provides responses from the remote memory 310 to the plurality of processor nodes 1-N. The node controller 320 includes a learning block 330 to monitor requests to a given data block in the remote memory 310 and to monitor parameters associated with the requests. The learning block 330 updates a respective weighting value for each of the parameters associated with the requests to the given data block in the remote memory 310. The respective weighting values indicate a likelihood of a subsequent memory action with respect to a prospective data block in the remote memory 310 that is accessed following each of the requests.

Event detection circuitry 340 stores the parameters and the weighting values for each of the parameters associated with an address for the given data block. The event detection circuitry 340 includes a content addressable memory (CAM) 350 has separate columns to store each of the parameters and its associated weighting value and a separate row assigned to each data block that has been previously requested by the processor nodes 1-N. The CAM 350 receives the address and the parameters as inputs to retrieve the weighting values. The event detection circuitry 340 determines the subsequent memory action for the prospective data block in the remote memory 310 based on matching an address of a current request to the given data block and comparing current parameter values associated with the current request relative to the stored parameters to determine the prospective data block.

A response manager 360 executes the subsequent memory action and monitors a future request from the processor nodes 1-N. The response manager 360 fulfills the future request to the processor nodes 1-N if the subsequent memory action matches the predicted, future request for a data block that has been retrieved and stored in a local buffer. The response manager 360 can execute the subsequent memory action determined by the event detection circuitry 340 and monitors a future memory request from the processor nodes 1-N. The response manager 360 fulfills the future memory request to the processor nodes 1-N if the subsequent memory action matches the future memory request. For example, the subsequent memory action can include a memory read, a memory write, a memory coherency directory operation, or a supervisory action that is applied to the remote memory.

Supervisory actions to the remote memory 310 can include operations to facilitate coherency of the remote memory (e.g., a state change to block or unblock a given memory location to allow one processor to read the location and write data back in a read-modify-write cycle). As used herein, the term coherency refers to the node controller's ability to manage concurrent data accesses to the remote memory 310 without one processor corrupting another processor's data access. Although not shown, the node controller 320 can also include a memory scrubber to update the weighting values stored in the CAM 350 depending on whether or not the subsequent memory action is fulfilled (e.g., if a given processor node actually requests the subsequent memory action taken by the node controller before the actual request to the remote memory).

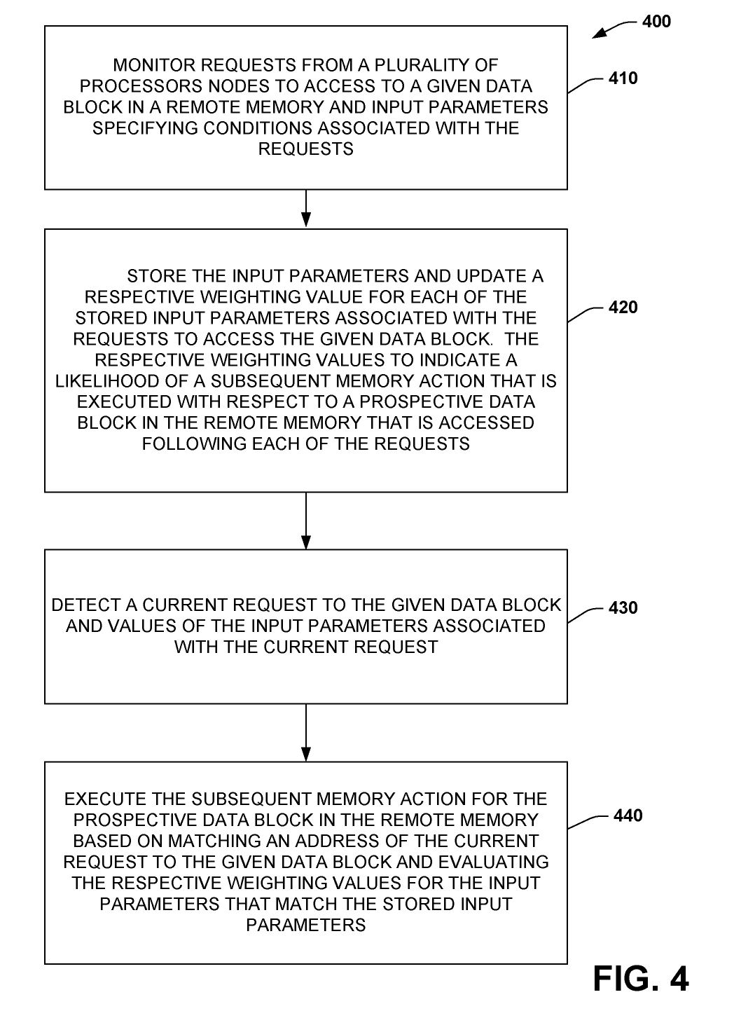

In view of the foregoing structural and functional features described above, an example method will be better appreciated with reference to FIG. 4. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured as machine readable instructions stored in memory and executable in an integrated circuit, controller, or a processor, for example.

FIG. 4 illustrates an example method 400 to determine future memory actions and manage memory accesses to a remote memory. At 410, the method 400 includes monitoring requests from a plurality of processors nodes to access to a given data block in a remote memory and input parameters specifying conditions associated with the requests (e.g., via learning block 130 of FIG. 1 and 330 of FIG. 3). At 420, the method 400 includes storing the input parameters and updating a respective weighting value for each of the stored input parameters associated with the requests to access the given data block. The respective weighting values indicate a likelihood of a subsequent memory action that is executed with respect to a prospective data block in the remote memory that is accessed following each of the requests (e.g., via learning block 130 of FIG. 1 and 330 of FIG. 3).

At 430, the method 400 includes detecting a current request to the given data block and values of the input parameters associated with the current request (e.g., via event detection circuitry 140 of FIG. 1, 200 of FIG. 2, and 340 of FIG. 3). At 440, the method 400 includes executing the subsequent memory action for the prospective data block in the remote memory based on matching an address of the current request to the given data block and evaluating the respective weighting values for the input parameters that match the stored input parameters (e.g., via event detection circuitry 140 of FIG. 1, 200 of FIG. 2, and 340 of FIG. 3).

Although not shown, the method 400 can include summing weighting values associated with a content addressable memory in response to parameters associated with the current memory requests of the processor nodes and comparing the summed weighting values to a threshold. Along with addition, the summing process can also include subtraction, multiplication, division, and the shifting of the value associated with the other rows to the left or right to modify the weighting values. The summing process may also include passing the value associated with another or substituting a constant value. Because of a possible circuit delay for an addition operation, an example summing operation can be to shift, pass or replace a value from the CAM row above. For example, all of the rows that miss would pass the value received from the row above and the CAM rows that matched would shift the value they received to the left to increase and the right to decrease.

Some match or miss CAM rows would thus not pass the weighting value but would replace the current value with a constant value to start the chain of shifting values in another cycle. The method can include executing the predictive memory action if the summed weighting values exceed the threshold. The method 400 can also include monitoring future requests from the processor nodes to corresponding data blocks in the remote memory and parameters associated with each of the future requests. This can include fulfilling the future request to the processor nodes based on data retrieved from the remote memory and stored locally in response to performing the subsequent memory action prior to the future request.

What have been described above are examples. One of ordinary skill in the art will recognize that many further combinations and permutations are possible. Accordingly, this disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A circuit, comprising:
a node controller to manage access to and provide responses from a remote memory for a plurality of processor nodes, the node controller comprising:
a learning block to monitor requests to a given data block in the remote memory and to monitor parameters associated with the past requests, the learning block updates a respective weighting value for each of the parameters associated with the requests to the given data block, the respective weighting values to indicate a likelihood of a subsequent memory action with respect to a prospective data block in the remote memory that is accessed following each of the requests; and
event detection circuitry to store the parameters and the weighting values for each of the parameters associated with an address for the given data block, the event detection circuitry to determine the subsequent memory action for the prospective data block in the remote memory based on matching an address of a current request to the given data block and matching current parameter values associated with the current request relative to the stored parameters to determine the prospective data block.

2. The circuit of claim 1, wherein the event detection circuitry further comprises a summer and a comparator, the summer to generate a summed weighting value in response to weighting values retrieved from the matched current parameter values, the comparator to compare the summed weighting value from the stored parameters to a threshold, the summed weighting value is provided based on the current parameter values matching stored parameter values for the address for the given data block, wherein the event detection circuitry determines the subsequent memory action if the summed weighting value exceeds the threshold.

3. The circuit of claim 2, wherein the event detection circuitry includes a content addressable memory (CAM) having separate columns to store each of the parameters and a separate row assigned to each data block that has been previously requested by the processor nodes, the CAM receives the row and the parameters as inputs to retrieve the weighting values.

4. The circuit of claim 3, wherein the CAM is implemented as a ternary CAM (TCAM) to allow for the specification of do not care state inputs representing the parameters to the content addressable memory.

5. The circuit of claim 3, wherein the CAM further comprises:
a primary TCAM to perform an initial search for respective weighting values based on the parameters, wherein weighting values associated with the primary TCAM rows are summed via the summer to provide the summed weighting value, wherein the comparator compares the summed weighting value to the threshold; and
a secondary TCAM to lookup the subsequent memory action based on the address of the given data block if the comparator indicates that the summed weighting value exceeds the threshold.

6. The circuit of claim 1, further comprising a response manager to execute the subsequent memory action determined by the event detection circuitry and to monitor a future request from the processor nodes, the response manager fulfills the future request to the processor nodes if the subsequent memory action matches the future request, the subsequent memory action includes a memory read, a memory write, or a supervisory action to the remote memory.

7. The circuit of claim 6, further comprising a memory scrubber to update the weighting values stored in the event detection circuitry depending on whether or not the future request matches the subsequent memory action.

8. The circuit of claim 1, wherein the learning block comprises a classifier to monitor the requests to a given data block in the remote memory and updates the respective weighting value for each of the parameters as a statistical probability to indicate the likelihood of the subsequent memory action.

9. The circuit of claim 1, wherein the parameters include at least two of a time of day, a day of the week, a day of the month, a month of the year, a type of memory request, or an address range of the request.

10. The circuit of claim 1, wherein the parameters include a previous address accessed, an access request history, a processor address region, coherency directory information, a previous request history, or a running application identifier.

11. A method, comprising:
monitoring requests from a plurality of processors nodes to access to a given data block in a remote memory and input parameters specifying conditions associated with the requests;
storing the input parameters and updating a respective weighting value for each of the stored input parameters associated with the requests to access the given data block, the respective weighting values to indicate a likelihood of a subsequent memory action that is executed with respect to a prospective data block in the remote memory that is accessed following each of the requests;
detecting a current request to the given data block and values of the input parameters associated with the current request; and
executing the subsequent memory action for the prospective data block in the remote memory based on matching an address of the current request to the given data block and evaluating the respective weighting values for the input parameters that match the stored input parameters.

12. The method of claim 11, further comprising:
summing weighting values retrieved from a content addressable memory in response to parameters associated with the current memory requests of the processor nodes;
comparing the summed weighting values to a threshold; and
executing the predictive memory action if the summed weighting values exceed the threshold.

13. The method of claim 11, further comprising:
monitoring future requests from the processor nodes to corresponding data blocks in the remote memory and parameters associated with each of the future requests; and
fulfilling the future request to the processor nodes based on data retrieved from the remote memory and stored locally in response to performing the subsequent memory action prior to the future request.

14. A system, comprising:
a remote memory;
a plurality of processor nodes;
a node controller to manage access to and provide responses from the remote memory to the plurality of processor nodes, the node controller comprising:
a learning block to monitor requests to a given data block in the remote memory and to monitor parameters associated with the requests, the learning block updates a respective weighting value for each of the parameters associated with the requests to the given data block, the respective weighting values to indicate a likelihood of a subsequent memory action with respect to a prospective data block in the remote memory that is accessed following each of the requests;
event detection circuitry to store the parameters and the weighting values for each of the parameters associated with an address for the given data block, the event detection circuitry includes a content addressable memory (CAM) having separate columns to store each of the parameters and a separate row assigned to each data block that has been previously requested by the processor nodes, the CAM receives the address and the parameters as inputs that are employed to retrieve associated weighting values, the event detection circuitry determines the subsequent memory action for the prospective data block in the remote memory based on matching an address of a current request to the given data block and comparing current parameter values associated with the current request relative to the stored parameters to determine the prospective data block; and
a response manager to execute the subsequent memory action and to monitor a future request from the processor nodes, the response manager fulfills the future request to the processor nodes if the subsequent memory action matches the future request.

15. The system of claim 14, wherein the node controller further comprises a memory scrubber to update the weighting values stored in the CAM depending on whether or not the future request matches the subsequent memory action.
